(19) United States
(12) Patent Application Publication
(10) Pub. No.: US 2026/0091724 A1
(43) Pub. Date: Apr. 2, 2026

(54) CAMERA-BASED CONTROL OF A LIGHT EMISSION ANGLE OF A VEHICLE HEADLIGHT

(71) Applicant: Ford Global Technologies, LLC, Dearborn, MI (US)

(72) Inventors: Matthias Christian Reiter, Aachen (DE); Gerald Doerne, Köln (DE); Vincent Jannick Frisch, Köln (DE); Lars Michael Lottner, Odenthal (DE); Stefan Lingscheidt, Köln (DE); Michael Koherr, Euskirchen (DE)

(21) Appl. No.: 19/329,181

(22) Filed: Sep. 15, 2025

(30) Foreign Application Priority Data
Sep. 27, 2024 (DE) 102024128060.3

(51) Int. Cl. B60Q 1/115; B60Q 1/14

(52) U.S. Cl. CPC B60Q 1/115; B60Q 1/143; B60Q 2200/38; B60Q 2300/132; B60Q 2300/134

(57) ABSTRACT

This disclosure relates generally to vehicle headlights and, more particularly, to camera-based control of the light emission angle of a vehicle headlight. An example headlight leveling apparatus includes interface circuitry, machine readable instructions, programmable circuitry to execute the machine readable instructions to based on at least one image captured by a front camera of a vehicle, determine a geometric relationship between an output light emitting direction of a headlight and a direction defining a current orientation of the front camera, determine a current pitch angle of the front camera based on images captured by the front camera, and control a vertical light emission angle of the headlight based on the geometric relationship and the current pitch angle of the front camera.

### RELATED APPLICATION

This patent claims priority from DE Patent Application Number 102024128060.3, which was filed on Sep. 27, 2024, and is hereby incorporated by reference in its entirety.

### FIELD OF THE DISCLOSURE

This disclosure relates generally to vehicle headlights and, more particularly, to camera-based control of the light emission angle of a vehicle headlight.

### BACKGROUND

Modern vehicles typically require a headlight leveling calibration procedure which is completed during the manufacturing process. Headlight leveling calibration is also required when calibrating other vehicle systems such as a vehicle-based camera system.

### SUMMARY

An example headlight leveling apparatus includes interface circuitry, machine readable instructions, programmable circuitry to execute the machine readable instructions to based on at least one image captured by a front camera of a vehicle, determine a geometric relationship between an output light emitting direction of a headlight and a direction defining a current orientation of the front camera, determine a current pitch angle of the front camera based on images captured by the front camera, and control a vertical light emission angle of the headlight based on the geometric relationship and the current pitch angle of the front camera.

An example method for controlling a horizontal angle of light emission of a headlight of a vehicle includes based on at least one image captured by a front camera of the vehicle, determining a geometric relationship between an output light emitting direction of a front headlight and a direction defining a current orientation of the front camera, determining a current yaw angle of the front camera with respect to a longitudinal axis of the vehicle based on an image captured by the front camera, controlling a horizontal light emission angle of the front headlight based on the geometric relationship and the current yaw angle of the front camera.

An example vehicle includes a headlight, an electric motor coupled to the headlight, a camera, and a controller configured to determine a geometric relationship between an output light emitting direction of the headlight and a direction defining a current orientation of the camera based on at least one image captured by the camera, determine a current pitch angle of the camera based on the at least one image captured by the camera, and cause the motor to adjust a vertical light emission angle of the headlight based on the geometric relationship and the current pitch angle of the camera.

### BRIEF DESCRIPTION OF DRAWINGS

FIG. 1 shows an example vehicle and a calibration of the light emission angle of a headlight.

FIG. 2A shows a leveling of the light emission angle of an example vehicle's headlight.

FIG. 2B shows a leveling of the light emission angle of an example vehicle's headlight.

FIG. 3 shows an example vehicle which projects a light cone of its headlamp onto a house wall in accordance with a method described herein.

FIG. 4 shows the example vehicle of FIG. 3 which projects a light cone of its headlamp onto a house wall in accordance with a method described herein.

FIG. 5 shows the example vehicle of FIG. 3 projecting a light cone of its headlamp onto a house wall in accordance with a method described herein.

FIG. 6 shows a projection of a beam of light from an example vehicle's headlights onto a house wall.

FIG. 7 shows an example vehicle and an oncoming vehicle in a plan view.

FIG. 8 shows an example vehicle with a control device in accordance with examples described herein.

FIG. 9 is a block diagram of an example processing platform including programmable circuitry structured to execute, instantiate, and/or perform the example machine readable instructions and/or perform the example operations described herein to implement the control device of FIG. 8.

In general, the same reference numbers will be used throughout the drawing and accompanying written description to refer to the same or like parts. The figures are not necessarily to scale.

### DETAILED DESCRIPTION

Examples described herein provide a method for controlling (e.g., adjusting and/or regulating) the vertical light emission angle of a front headlamp (e.g., headlight) of a vehicle and a method for controlling the horizontal light emission angle of a front headlamp of a vehicle. Examples described herein further provide for a control device for controlling the light emission angle of a headlamp of a vehicle, a vehicle, a computer-implemented method, a computer program product, a computer-readable data carrier, and a data carrier signal.

Usually, the headlight range of a headlight can be adjusted or corrected manually and/or automatically (e.g., by using a stepper motor, a stepper motor coupled to the headlight). Furthermore, glare-free high beam systems and headlights with camera-based dynamic headlight range control are known.

The aforementioned systems, especially the camera-based ones, require the camera and the headlights to be calibrated under the same controlled conditions (e.g., that they are oriented in a defined way in relation to the vehicle). Calibration is also known as aiming. Joint calibration is necessary because installation and manufacturing tolerances are significantly larger than acceptable tolerances for headlight range control.

A range control of a vehicle's headlight usually includes the following operations. First, an adjustment position of the headlight is determined. The prerequisite for this is an adjustment of a zero angle (e.g., an initial calibration angle, a baseline angle). Thus, with the nominal basic setting of a stepper motor angle, the headlight is calibrated as part of the assembly in such a way that a fixed light emission slope is achieved. Normally, at the end of the production line, the headlight is set to a zero position. Headlights as a component and the headlight mounting in an overall vehicle system contain large mechanical tolerances. The angle is corrected via adjusting screws or electronic control so that the light exits at a fixed angle. This process is also known as adjustment or aiming and provides the adjustment position as a prerequisite for any further compensation. The subsequent headlight range control, also known as leveling, detects changes in the angle between the vehicle and the ground and compensates for the fixed light emission angle or the required deviation from the adjustment position.

The prior art in this regard is disclosed, for example, in documents DE 10 2019 207 838 A1, which describes a method for directing the light beams emitted by the headlights of a motor vehicle, U.S. Pat. No. 10,227,032 B2, where a system for adjusting a headlamp of a motor vehicle is described, CN 202 794 722 U and CN 103 373 274 B.

The light beam direction of each headlight is subject to individual manufacturing tolerances, which can have a size of several degrees due to the respective appearance and the mounting of the headlight inside the vehicle. The aiming required at the end of the manufacturing process, in which the orientation of the headlight is adapted to the vehicle, is traditionally carried out via adjustment screws. Electronic actuation via an electric motor, pixel adjustment, or simply recording the deviation of the current setting from a target setting are also possible.

If the headlight is correctly calibrated in the vertical direction, a Dynamic Headlamp Leveling system can be used to maintain a constant beam angle with respect to the ground, even if the car's pitch angle changes. In some examples, it is at least possible to compensate for load-related changes in pitch angle. Compensation is traditionally completed in terms of a nominal pitch angle. For example, if the vehicle's pitch angle increases by 1 degree from the nominal pitch angle, a 1 degree reduction in the beam angle is made from a nominal setting.

Traditionally, each vehicle must be individually calibrated at the end of the manufacturing process due to manufacturing tolerances, individual equipment-related load, suspension and damping conditions, as well as individual sensor installations. A sensor output signal (e.g., the output signal of a height sensor) must be determined for each vehicle, which corresponds to the nominal condition of the vehicle. A load-related change in pitch angle can be determined, for example, via height sensors or cameras while driving.

Existing systems effectively use two separate measurement mechanisms for calibration. The first system determines the reference pitch angle of the vehicle at the end of production. In the case of height sensors, this means storing the raw output data. In the case of using a camera, visually detectable patterns are used to determine the pixel position, which points straight ahead in relation to the vehicle. The second system adjusts the headlights individually so that their beam angle has a predetermined (e.g., defined) slope. In both cases, the sensor calibration and the headlight calibration are carried out under the same vehicle conditions.

Examples described herein provide methods for controlling (e.g., adjusting and/or regulating) the vertical or horizontal light emission angle of a headlamp of a vehicle. Further, examples described herein provide a control device (e.g., electronic control unit (ECU)) for controlling the light emission angle of a vehicle's headlamp, a vehicle, a computer-implemented method, a computer program product, and a non-transitory computer-readable medium.

An example method for controlling (e.g., adjusting, calibrating, and/or regulating) the vertical light emission angle of a vehicle headlamp of a vehicle refers to a vehicle including a camera (e.g., a front camera) and a device (e.g., electric motor) for adjusting the light emission angle of the front headlamp.

The example method includes at least the following operations. In a first operation, based on at least one image captured by the camera (e.g., image-based) a geometric relationship between an output light emission direction of the front headlight and a direction defining the current orientation (e.g., the vertical orientation) of the camera is determined (e.g., calculated). The direction that defines the current orientation of the camera can be an optical axis of the camera or a central image acquisition direction.

In a second operation, a current pitch angle of the camera (e.g., in relation to the direction defining the orientation of the camera) is determined based on images captured by the camera during a journey (e.g., during a translational movement) of the vehicle. In a third operation, the vertical light emission angle of the front headlight is controlled (e.g. adjusted) based on the determined geometric relationship between the output light emission direction of the front light and the direction defining the current orientation of the front camera and based on the determined current pitch angle of the front camera.

In the context of the described examples, the vehicle may be, for example, a motor vehicle or a rail vehicle. A front camera is a camera that is configured to capture images in a forward direction of the vehicle or in the direction of travel. The device already mentioned for adjusting the light emission angle of the headlight may include, for example, a stepper motor.

An example method for controlling the horizontal light emission angle of a front headlamp of a vehicle, which includes a front camera and a device for adjusting the light emission angle of the front headlight, includes at least the following operations. In a first operation, based on at least one image captured by the front camera, a geometric relationship between an output light emission direction of the front headlight and a geometric relationship between an output light emission direction of the front headlight and a current orientation (e.g., horizontal orientation) of the front camera is determined (e.g., calculated).

In a second operation, the current yaw angle or yaw angle of the front camera in relation to a longitudinal axis of the vehicle is determined (e.g., calculated) based on images captured by the front camera while the vehicle is in motion (e.g., during a translational movement of the vehicle). In a third operation, the horizontal light emission angle of the front light is controlled (e.g., adjusted) based on the determined geometric relationship between the output light emission direction of the front light and the direction defining the current orientation of the front camera, and based on the determined current yaw angle of the front camera.

Examples described herein have at least the following advantages. Compared to the calibration methods and calibration systems known from the prior art, which are complex both in the manufacture of a vehicle and in its operation and maintenance, require installation space and trained personnel, special measuring instruments and a special calibration stand or a corresponding setup for the application, examples describe herein offer a simple, reliable and robust variant that can be applied flexibly without a special setup or specialist personnel. By calibrating or adjusting the camera and headlights together only in relation to each other and not in relation to the vehicle, an addition of errors can also be avoided. This improves the precision and reliability of the control of the respective light emission angle.

Furthermore, calibration and adjustment is simplified overall, as both the front camera and the respective front headlight can be aligned with a higher tolerance in relation to the vehicle so that these two calibration operations (e.g., the calibration of the front camera and the calibration of the front headlight) can be carried out with less effort than was previously the case. In particular, there is no need to set precise, fixed zero positions at the end of the manufacturing process. Instead, according to examples described herein, it is possible by determining a geometric relationship between the orientation of the camera and the headlamp the light emission angle of a headlamp with respect to the ground (e.g., in the vertical direction, or in the horizontal direction) via a front camera whose central image acquisition direction or optical axis is not calibrated with respect to the vehicle, for example using only a captured image of the projection of the light cone of the headlight on a screen or wall at a known distance from the camera and the headlight. While driving, the angle between the uncalibrated central image acquisition direction or the optical axis of the front camera and the ground or horizon can then be determined on the basis of an image. With this information alone, it is possible to determine a misalignment of the light beam angle of the headlight with respect to the reason for calculating a corresponding correction variable.

Another advantage of the examples disclosed herein is that recalibration can be carried out in the field at any time, especially without the need to unload the vehicle. On the other hand, according to the state of the art, it is necessary for recalibration that the vehicle is unloaded and that the same conditions prevail for maintenance of the sensor system for detecting the pitch angle of the vehicle as the headlamps were calibrated. So, both the sensor system and the headlights need to be calibrated as part of the same repair operation. This requires that a person performing the repair has access to both systems and is trained to do so. This is usually only the case with a workshop that also replaces height sensors. However, a recalibration of a camera-based system is often only required as part of a windshield replacement that can also be completed outside of a specialist workshop. In contrast, the examples described herein allow calibration of the camera as part of a system for determining pitch angles and the direction of light emitting or the headlight range of the headlights without the need for a workshop.

In some examples, the geometric relationship between the initial light emitting direction of the front headlight and the direction defining the current orientation of the front camera can be determined via an image of the emitted light captured by the front camera (e.g., a projection of the light cone of the front headlight onto a projection surface). A screen (e.g., a screen, a sign, or a wall) can be used as a projection surface. Advantageously, the distance of the projection surface from the front camera can be determined.

Furthermore, the image of the light emitted by the headlight captured by the front camera can be used to determine an angle between the direction defining the orientation of the front camera (e.g., a centerline or central axis of the image acquisition direction or a horizontal or vertical line) and a boundary line (e.g. a horizontal or vertical boundary line) of the emitted light on the projection surface. The angle can be determined directly from the position in the captured image where the boundary line is located. For example, the pixel position in the image can correspond to or be equivalent to the angle to the reference line (e.g., a direction that defines the orientation of the camera.

In some examples, a correction angle of the light emission angle of the front light is calculated using the horizontal distance and the vertical distance of the front light from the front camera and the distance of the front light or the front camera to a projection surface.

In some examples, the vertical light emission angle of the headlight can be controlled (e.g., adjusted and/or regulated) in relation to a camera-based current horizon line or horizon plane.

In some examples, the horizontal light emission angle of the headlight can be controlled in relation to a camera-based current vertical reference line or reference plane (e.g., a longitudinal axis or a vertical longitudinal plane) of the vehicle.

The front camera can be used to determine the current pitch angle and/or the current yaw angle of the front camera. This has the advantage that no additional or additional sensor technology is required.

An example control device for controlling (e.g., adjusting and/or regulating) the light emission angle of a headlamp of a vehicle, which includes a front camera and a device for adjusting the light emission angle of the headlamp, is configured for receiving and evaluating images (e.g., data, image data) captured via the front camera and for executing a method according to the examples described above. The control device according to examples described herein includes the features and advantages already described above.

An example vehicle includes a front camera and a device for adjusting (e.g., controlling or adjusting) the light emission angle of the headlamp. The example vehicle includes a control device according to examples described above. The example vehicle includes the advantages already described. The example vehicle can be a motor vehicle, a rail vehicle, or a ship. The motor vehicle can be a passenger car, a sport utility vehicle, a truck, a bus, a minibus, a motorcycle or a moped.

An example computer-implemented method according to examples described herein includes commands which, when executed by a computer, cause it to execute an example method described above. An example computer program product according to examples described herein includes commands which, when executed by a computer, cause it to execute an method described above. The example computer program product is stored on an example non-transitory computer readable medium according to examples described herein. The example computer-implemented method, the example computer program product, and the example non-transitory computer readable medium include the features and advantages already mentioned above.

Examples described herein are explained below with reference to the attached figures. Although examples described herein are illustrated and described in detail, the examples described herein are not limited by the disclosed examples and other variations can be inferred by the skilled person without leaving the scope of the examples described herein.

The term “and/or” used herein, when used in a series of two or more elements, means that each of the listed elements can be used alone, or any combination of two or more of the listed elements can be used. For example, if a composition containing components A, B and/or C is described, composition A alone; B alone; C alone; A and B in combination; A and C in combination; B and C in combination; or A, B, and C in combination.

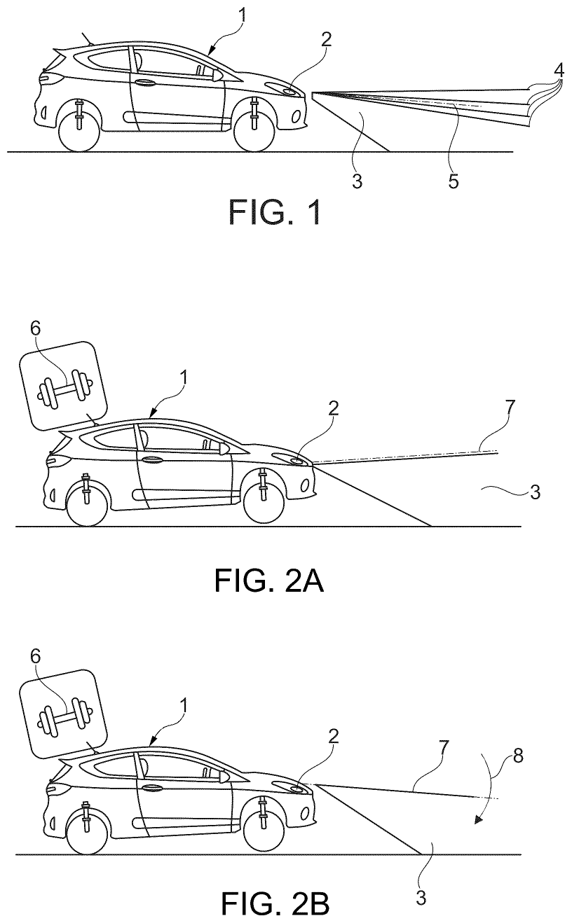

FIG. 1 shows a vehicle 1 (e.g., a motor vehicle. The vehicle 1 includes a headlight 2. The light beam emitted by the headlight 2 has a slope that determines or is influenced by the angle of light emission. The upper edge of the light cone 3 in the vertical direction is used as a reference value. Prior to calibration, the vehicle 1 includes different beam angles or different pitches of the emitted light 3 with respect to the ground 12 or a flat road surface. Example pitches or slopes are indicated by lines with reference numbers 4. The desired nominal slope is indicated by a dash-dot line with the reference digit 5. The front headlights of the vehicle 1 are calibrated to the nominal light emission angle or nominal pitch 5 after the manufacturing process. This can be done electronically or via adjusting adjustment screws. During calibration, the vehicle 1 is in an unloaded state.

As a result of a load on the vehicle 1, a pitch angle of the vehicle 1 may change and cause a change in the light emission angle of the headlight 2 and thus a change in the slope 7 of the emitted light 3. This is shown in FIG. 2A. The vehicle 1 shown is heavily loaded in the rear area, which is indicated by a weight 6. This causes the pitch angle of vehicle 1 to increase with respect to a nominal pitch angle and, as a result, the light emission angle has an increased slope (e.g., deviates upwards from the nominal slope 5).

In FIG. 2B, this has been corrected by a headlight range adjustment or adjustment. For example, the light emission angle has been changed by minus one degree or adapted to the current pitch angle of the vehicle 1. This is indicated by an arrow 8. This ensures that the nominal slope 5 of the emitted light is also maintained at the current light emission angle when the vehicle 1 is loaded.

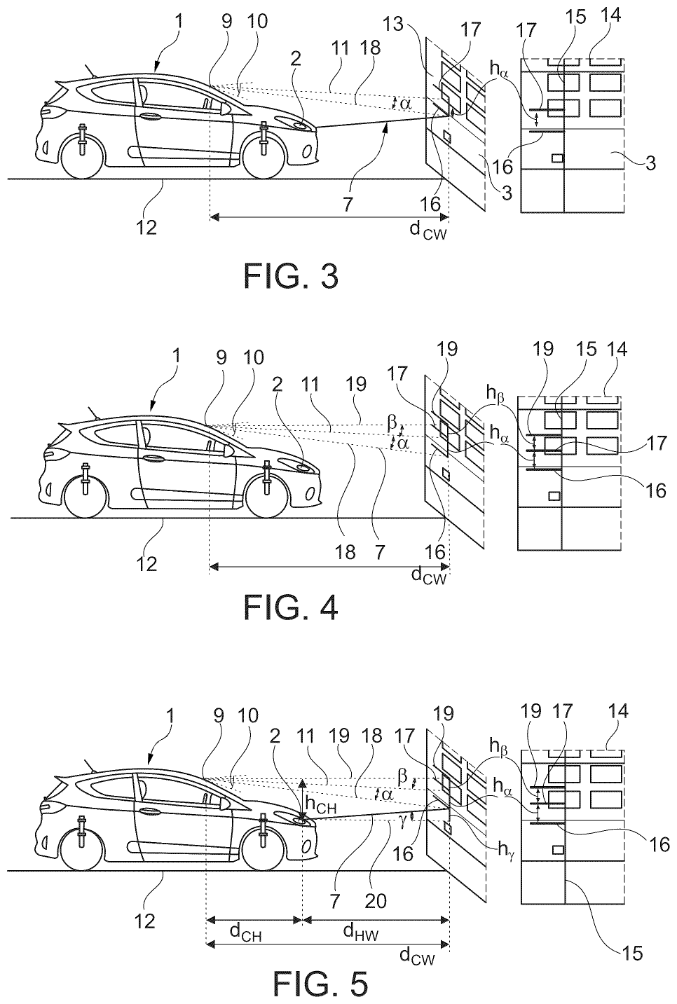

FIGS. 3-5 each show the vehicle 1 whose headlight 2 projects or emits light onto a wall 13 shown in a perspective view. The vehicle 1 includes a front camera 9 and a device for adjusting the angle of light emission of the headlight 2, which is not explicitly shown. The field of view of the front camera 9, which is also referred to as the camera in the following, is indicated by a bar with the reference number 10. Similar to the alignment of the headlights, the exact alignment of the camera's optical axis is tolerant and vehicle specific.

Via the headlight 2, light is beamed onto the wall 13 arranged vertically to the ground 12. In the present example, the wall 13 is a house wall. Alternatively, any projection surface, such as a screen, can be used. The front camera 9 captures the light projection of the headlight 2 onto the wall 13.

In a first operation shown in FIG. 3, a geometric relationship between an output light emitting direction 7 of the headlight 2 and a direction defining the current orientation of the front camera 9 is determined. In such examples, the direction defining the current orientation is determined (e.g., calculated) based on at least one image 14 captured by the front camera 9. The distance dCW between the wall 13 and the front camera 9 is assumed or measured. In the captured image 14, the distance ha between a vertically upper boundary line 16 of the light cone 3 and a vertical position 17 of a centerline or central axis 11 of the front camera 9 is determined with respect to a vertical direction 15. The distance ha corresponds to the angle α between the central axis 11 and a sensing direction 18 of the vertically upper boundary line 16 of the light cone 3.

None of the exact direction of detection or the orientation of the front camera 9, or the exact beam angle of the front headlamp 2 are known with regard to their orientation with respect to the vehicle body, as no calibration has yet been carried out. Both the front camera 9 and the headlight 2 are only oriented as they have been installed and usually deviate from their ideal orientation in relation to vehicle 1 by a few degrees.

In an operation shown in FIG. 4, the current pitch angle of the front camera 9 with respect to the ground 12 (e.g., in such examples the angle β between vertical position 17 of the central axis 11 and the ground 12) is calculated based on images captured by the front camera 9 during a translational movement (e.g., during a journey) of vehicle 1. In this context, a mean horizon position can be determined. The mean vertical position of the horizon line, which is drawn as line 19 on wall 13 or in the captured image 14 for illustration, correlates with the load-dependent pitch angle of the vehicle 1. The mean horizon line 19 may be determined from a series of sequential images taken during a vehicle journey.

In the shown image 14, the horizon line 19 is equivalent to the pixels that point “straight ahead” (e.g., correspond parallel to the ground 12 captured pixels). The angle β corresponds to the distance h in the vertical direction 15 between the vertical position of the central axis 11 of the front camera 9 and the horizon line 19. In some examples, no deviation of the current horizon line 19 from an initial horizon line is determined or used. In such examples, all that is required is the current horizon line or its position.

In a third operation, based on the determined geometric relationship between the initial light emission direction 7 of the front headlight 2 and the direction defining the current orientation of the front camera 9 (e.g., the angle α) and based on the determined current pitch angle β the front camera 9, the vertical light emission angle of the front headlight 2, (e.g., the light emission angle) is calculated with respect to the ground 12. This is shown in FIG. 5. An angular deviation γ the uncalibrated output beam angle 7 from a horizontal direction 20 is determined. Here, the distance hγ correlating with the angle γ can be determined and used on the basis of an image.

Via this angle γ, a light emission angle with respect to the ground 12 can be controlled, whereby in particular the angle γ can be compensated by adding to the desired angle of slope or the desired slope. The vertical distance hCH between the front light 2 and the front camera 9, and the horizontal distance dCH between the front light 2 and the front camera 9 as well as the horizontal distance dHW between the front light 2 and the wall 13 can be assumed to be known, measured, or calculated. With the help of these quantities, the angle γ can be calculated according to the following equation. The angle γ then serves as the basis for controlling the vertical light emission angle of the headlight 2.

$$tan ( γ ) = \frac{{h}_{γ}}{{d}_{HW}} = \frac{{h}_{CH} - {h}_{α} - {h}_{β}}{{d}_{CW} - {d}_{CH}} = \frac{{h}_{CH} - tan \cdot {d}_{CH}}{{d}_{CW} - {d}_{CH}}$$

In addition to the example described, images can also be captured and evaluated at several different distances to the wall 13. This can improve the accuracy of the examples described.

Analogous to the examples described above, vertical control (e.g., calibration, adjustment, or regulation) of the light emission angle of the headlamp 2 can also be carried out via the front camera 9 without the requirement of a precise output calibration at the end of a manufacturing process. In such examples, a vertical reference line analogous to the horizon line 19 can be determined on the basis of the camera to determine the yaw angle of the front camera 9. For this purpose, a plurality of images taken one after the other during a journey of vehicle 1 can be evaluated to determine a vertical or vertical centerline or reference line in all images.

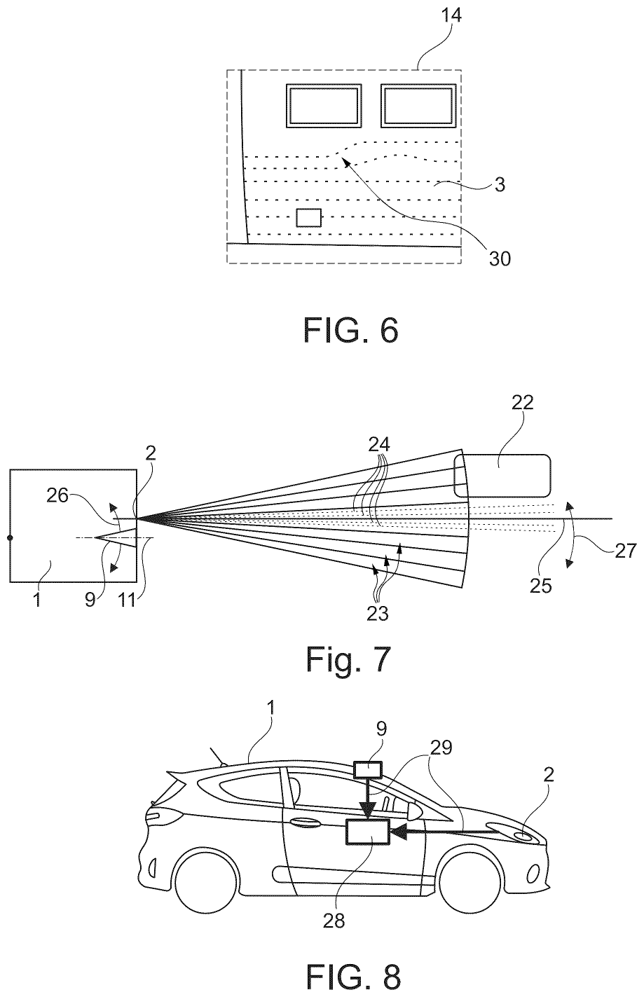

Furthermore, analogous to the examples described in reference of FIGS. 3-5, a geometric relationship can be determined between a central axis 11 of the front camera 9 and its horizontal position to a characteristic of the light cone 3 projected onto the wall 13 that characterizes the horizontal beam direction of the front headlight 2. An example projection is shown in FIG. 6. Depicted in FIG. 6, a bend or kink (e.g., distortion of light, bending of light, etc.) 30 is visible as a suitable reference feature, which can be used for horizontal calibration and/or adjustment analogous to the upper edge 16.

FIG. 7 shows the vehicle 1 and an oncoming vehicle 22 in a plan view. The vehicle 1 includes a front camera 9 and at least one front headlight 2. The front camera 9 is not initially calibrated or adjusted with regard to its central axis or mean image acquisition direction (e.g., its orientation with respect to a longitudinal axis of the vehicle). This is indicated by arrow 26. The direction of beam or light emitting of the headlamp 2 can be controlled in the horizontal direction via a suitable device. This is indicated by an arrow 27.

At the end of a manufacturing process, the vehicle 1 may include the light emitting directions of the headlamp 2, indicated by reference number 24 by way of example. The aim is to achieve a nominal light emission direction of 25. A corresponding control (e.g., in the form of calibration or adjustment) can be carried out according to an analogous procedure to the procedure already described in reference to FIGS. 3-5, using the bend 30 shown in FIG. 6 as a reference feature.

In this context, (e.g., in the case of an LED headlight) the radiation intensity of individual pixels of a headlight 2 can be controlled. This is indicated by the reference number 23, which illustrates the light cones of individual rows of pixels. For example, in the case of individually controllable LED light sources of the headlight 2, individual pixels can be individually controlled in terms of their intensity and/or beam direction within the framework of a pixel matrix to achieve the desired nominal beam direction.

A vehicle 1 according to examples described herein is shown schematically in FIG. 8. It includes a control device 28 for controlling the angle of light emission of a headlamp 2, which is not explicitly shown in the other figures. The control device 28 is configured to receive and evaluate images captured by the front camera 9 and to carry out a procedure for controlling the light emission angle of the headlamp 2, which is described by way of example in FIGS. 3-7.

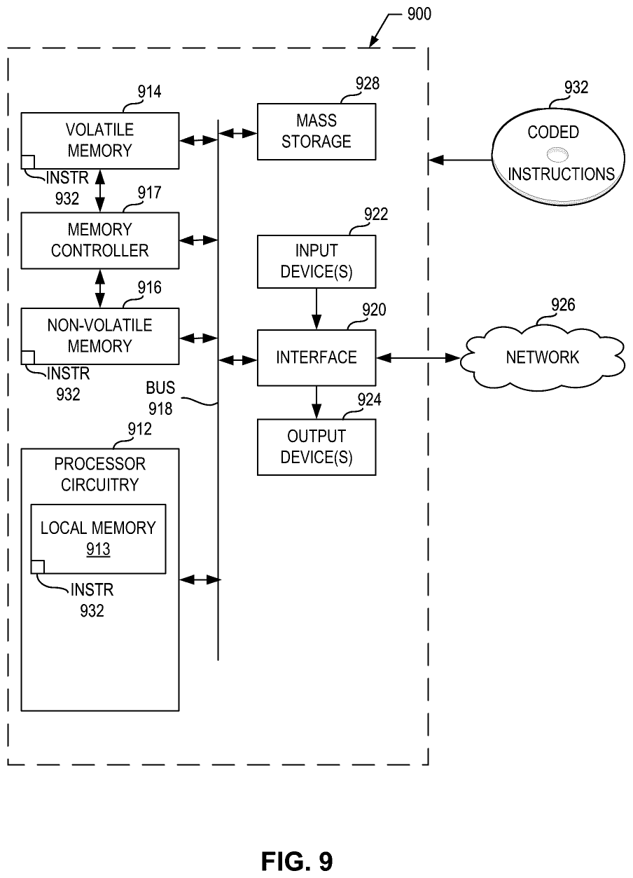

FIG. 9 is a block diagram of an example programmable circuitry platform 900 structured to execute and/or instantiate the example machine-readable instructions and/or the example operations disclosed herein. The programmable circuitry platform 900 can be, for example, a control device, an electronic control unit (ECU), a self-learning machine (e.g., a neural network), or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 912 may be implemented by one or more semiconductor based (e.g., silicon based) devices.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a button, a touchscreen, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 932, which may be implemented by the machine-readable instructions described herein, may be stored in the mass storage device 928, in the volatile memory 914, in the non-volatile memory 916, and/or on at least one non-transitory computer readable storage medium such as a CD or DVD which may be removable.

Example methods, apparatus, systems, and articles of manufacture for camera-based control of a light emission angle of a vehicle headlight are disclosed herein. Further examples and combinations thereof include the following:

Example 1 includes a headlight leveling apparatus comprising interface circuitry, machine readable instructions, programmable circuitry to execute the machine readable instructions to based on at least one image captured by a front camera of a vehicle, determine a geometric relationship between an output light emitting direction of a headlight and a direction defining a current orientation of the front camera, determine a current pitch angle of the front camera based on images captured by the front camera, and control a vertical light emission angle of the headlight based on the geometric relationship and the current pitch angle of the front camera.

Example 2 includes the headlight leveling apparatus of example 1, wherein the vertical light emission angle of the headlight is controlled with respect to a camera-based current horizon line.

Example 3 includes the apparatus of any one or more of examples 1-2, wherein the geometric relationship is determined based on an image of emitted light of the headlight onto a projection surface captured by the front camera.

Example 4 includes the headlight leveling apparatus of example 3, wherein the projection surface is a screen or a wall.

Example 5 includes the apparatus of any one or more of examples 3-4, wherein a distance of the projection surface from the front camera is determined.

Example 6 includes the apparatus of any one or more of examples 3-5, wherein an angle between the direction defining an orientation of the front camera and a boundary line of the emitted light on the projection surface is determined based on the image of the emitted light of the headlight.

Example 7 includes the headlight leveling apparatus of example 6, wherein the angle between the direction defining the orientation of the front camera and the boundary line of the emitted light on the projection surface is determined based on a position in a captured image at which the boundary line is located.

Example 8 includes the apparatus of any one or more of examples 1-7, wherein a correction angle of the vertical light emission angle of the headlight is calculated based on a horizontal distance and a vertical distance of the headlight from the front camera and a distance of the headlight or the front camera to a projection screen.

Example 9 includes the apparatus of any one or more of examples 1-8, wherein the current pitch angle of the front camera is determined based on data captured by the front camera.

Example 10 includes a method for controlling a horizontal angle of light emission of a headlight of a vehicle comprising based on at least one image captured by a front camera of the vehicle, determining a geometric relationship between an output light emitting direction of a front headlight and a direction defining a current orientation of the front camera, determining a current yaw angle of the front camera with respect to a longitudinal axis of the vehicle based on an image captured by the front camera, controlling a horizontal light emission angle of the front headlight based on the geometric relationship and the current yaw angle of the front camera.

Example 11 includes the method of example 10, wherein the geometric relationship is determined based on an image of emitted light of the front headlight onto a projection surface captured by the front camera.

Example 12 includes the method of example 11, wherein the projection surface is a screen or a wall.

Example 13 includes the method of any one or more of examples 11-12, wherein a distance of the projection surface from the front camera is determined.

Example 14 includes the method of any one or more of examples 10-13, wherein an angle between the direction defining an orientation of the front camera and a boundary line of emitted light on a projection surface is determined based on the image of the emitted light of the headlight.

Example 15 includes the method of example 14, wherein the angle between the direction defining the orientation of the front camera and the boundary line of the emitted light on the projection surface is determined based on a position in a captured image at which the boundary line is located.

Example 16 includes the method of any one or more of examples 10-15, wherein a correction angle of the horizontal light emission angle of the headlight is calculated based on a horizontal distance and a vertical distance of the front headlight from the front camera and a distance of the front headlight or the front camera to a projection screen.

Example 17 includes the method of any one or more of examples 10-16, wherein the horizontal light emission angle of the headlight is controlled with respect to a camera-based current vertical reference line or reference plane.

Example 18 includes the method of any one or more of examples 10-17, wherein the current yaw angle of the front camera is determined based on data captured by the front camera.

Example 19 includes a vehicle comprising a headlight, an electric motor coupled to the headlight, a camera, and a controller configured to determine a geometric relationship between an output light emitting direction of the headlight and a direction defining a current orientation of the camera based on at least one image captured by the camera, determine a current pitch angle of the camera based on the at least one image captured by the camera, and cause the motor to adjust a vertical light emission angle of the headlight based on the geometric relationship and the current pitch angle of the camera.

Example 20 includes the vehicle of example 19, wherein the geometric relationship is determined further based on an image of emitted light of the headlight onto a projection surface.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A headlight leveling apparatus comprising:
interface circuitry;
machine readable instructions;
programmable circuitry to execute the machine readable instructions to:
based on at least one image captured by a front camera of a vehicle, determine a geometric relationship between an output light emitting direction of a headlight and a direction defining a current orientation of the front camera;
determine a current pitch angle of the front camera based on images captured by the front camera; and
control a vertical light emission angle of the headlight based on the geometric relationship and the current pitch angle of the front camera.

2. The headlight leveling apparatus of claim 1, wherein the vertical light emission angle of the headlight is controlled with respect to a camera-based current horizon line.

3. The headlight leveling apparatus of claim 1, wherein the geometric relationship is determined based on an image of emitted light of the headlight onto a projection surface captured by the front camera.

4. The headlight leveling apparatus of claim 3, wherein the projection surface is a screen or a wall.

5. The headlight leveling apparatus of claim 3, wherein a distance of the projection surface from the front camera is determined.

6. The headlight leveling apparatus of claim 3, wherein an angle between the direction defining an orientation of the front camera and a boundary line of the emitted light on the projection surface is determined based on the image of the emitted light of the headlight.

7. The headlight leveling apparatus of claim 6, wherein the angle between the direction defining the orientation of the front camera and the boundary line of the emitted light on the projection surface is determined based on a position in a captured image at which the boundary line is located.

8. The headlight leveling apparatus of claim 1, wherein a correction angle of the vertical light emission angle of the headlight is calculated based on a horizontal distance and a vertical distance of the headlight from the front camera and a distance of the headlight or the front camera to a projection screen.

9. The headlight leveling apparatus of claim 1, wherein the current pitch angle of the front camera is determined based on data captured by the front camera.

10. A method for controlling a horizontal angle of light emission of a headlight of a vehicle comprising:
based on at least one image captured by a front camera of the vehicle, determining a geometric relationship between an output light emitting direction of a front headlight and a direction defining a current orientation of the front camera,
determining a current yaw angle of the front camera with respect to a longitudinal axis of the vehicle based on an image captured by the front camera,
controlling a horizontal light emission angle of the front headlight based on the geometric relationship and the current yaw angle of the front camera.

11. The method of claim 10, wherein the geometric relationship is determined based on an image of emitted light of the front headlight onto a projection surface captured by the front camera.

12. The method of claim 11, wherein the projection surface is a screen or a wall.

13. The method of claim 11, wherein a distance of the projection surface from the front camera is determined.

14. The method of claim 10, wherein an angle between the direction defining an orientation of the front camera and a boundary line of emitted light on a projection surface is determined based on the image of the emitted light of the headlight.

15. The method of claim 14, wherein the angle between the direction defining the orientation of the front camera and the boundary line of the emitted light on the projection surface is determined based on a position in a captured image at which the boundary line is located.

16. The method of claim 10, wherein a correction angle of the horizontal light emission angle of the headlight is calculated based on a horizontal distance and a vertical distance of the front headlight from the front camera and a distance of the front headlight or the front camera to a projection screen.

17. The method of claim 10, wherein the horizontal light emission angle of the headlight is controlled with respect to a camera-based current vertical reference line or reference plane.

18. The method of claim 10, wherein the current yaw angle of the front camera is determined based on data captured by the front camera.

19. A vehicle comprising:
a headlight;
an electric motor coupled to the headlight;
a camera; and
a controller configured to:
determine a geometric relationship between an output light emitting direction of the headlight and a direction defining a current orientation of the camera based on at least one image captured by the camera;
determine a current pitch angle of the camera based on the at least one image captured by the camera; and
cause the motor to adjust a vertical light emission angle of the headlight based on the geometric relationship and the current pitch angle of the camera.

20. The vehicle of claim 19, wherein the geometric relationship is determined further based on an image of emitted light of the headlight onto a projection surface.
